(19) United States
(12) Patent Application Publication
(10) Pub. No.: US 2019/0160539 A1
(43) Pub. Date: May 30, 2019

(54) Additive Manufacturing with Overlapping Light Beams

(71) Applicant: Applied Materials, Inc., Santa Clara, CA (US)

(72) Inventors: Wei-Sheng Lei, San Jose, CA (US); Kashif Maqsood, San Francisco, CA (US); David Masayuki Ishikawa, Mountain View, CA (US)

(21) Appl. No.: 16/200,369

(22) Filed: Nov. 26, 2018

Related U.S. Application Data
(60) Provisional application No. 62/593,137, filed on Nov. 30, 2017.

(51) Int. Cl. B22F 3/105; C04B 35/64; B29C 64/268; B29C 64/277; B29C 64/153

(52) U.S. Cl. CPC B22F 3/1055; C04B 35/64; B29C 64/268; B33Y 10/00; B29C 64/153; B22F 2003/1058; B22F 2003/1057; B29C 64/277

(57) ABSTRACT

An additive manufacturing apparatus includes a platform, a dispenser configured to deliver a plurality of successive layers of feed material onto the platform, a light source assembly to generate a first light beam and a second light beam, a beam combiner configured to combine the first light beam and the second light beam into a common light beam, and a mirror scanner configured to direct the common light beam towards the platform to deliver energy along a scan path on an outermost layer of feed material.

### CROSS-REFERENCE TO RELATED APPLICATIONS

This application claims priority to U.S. Application Ser. No. 62/593,137, filed on Nov. 30, 2017, the entire disclosure of which is incorporated by reference.

### TECHNICAL FIELD

This disclosure relates to an energy delivery system for additive manufacturing, also known as 3D printing.

### BACKGROUND

Additive manufacturing (AM), also known as solid freeform fabrication or 3D printing, refers to a manufacturing process where three-dimensional objects are built up from successive dispensing of raw material (e.g., powders, liquids, suspensions, or molten solids) into two-dimensional layers. In contrast, traditional machining techniques involve subtractive processes in which objects are cut out from a stock material (e.g., a block of wood, plastic, composite, or metal).

A variety of additive processes can be used in additive manufacturing. Some methods melt or soften material to produce layers, e.g., selective laser melting (SLM) or direct metal laser sintering (DMLS), selective laser sintering (SLS), or fused deposition modeling (FDM), while others cure liquid materials using different technologies, e.g., stereolithography (SLA). These processes can differ in the way layers are formed to create the finished objects and in the materials that are compatible for use in the processes.

In some forms of additive manufacturing, a powder is placed on a platform and a laser beam traces a pattern onto the powder to fuse the powder together to form a shape. Once the shape is formed, the platform is lowered and a new layer of powder is added. The process is repeated until a part is fully formed.

### SUMMARY

This specification describes technologies relating to additive manufacturing with overlapping light beams or overlapping light beam spots.

In one aspect, an additive manufacturing apparatus includes a platform, a dispenser configured to deliver a plurality of successive layers of feed material onto the platform, a light source assembly to generate a first light beam and a second light beam, a beam combiner configured to combine the first light beam and the second light beam into a common light beam, and a mirror scanner configured to direct the common light beam towards the platform to deliver energy along a scan path on an outermost layer of feed material.

Implementations may include one or more of the following features.

The light source assembly may include a first light source configured to generate the first light beam directed towards the beam combiner, and a second light source configured to generate the second light beam directed towards the beam combiner. The light source assembly may include a light source configured to generate a third light beam, a beam splitter configured to split the third light beam into the first light beam and the second light beam, and a one or more optical components configured to modify a property of the first light beam relative to the second light beam before the first light beam is combined with the second light beam by the beam combiner.

The light source assembly may be configured such that the first light beam has a larger beam size than the second light beam. The light source assembly and beam combiner may be configured such that the first light beam completely surrounds the second light beam. The first light beam may have a first power density and the second light beam may have a second power density that is different from the first power density. The first power density may be lower than the second power density. The light source assembly may be configured such that the first light beam has a first beam radius that is greater than a second radius of the second light beam. The light source assembly and beam combiner may be configured such that a center of the first light beam is offset from a center of the second light beam.

The beam combiner may be configured such that the first light beam and the second light beam are coaxial in the common light beam. The first light beam may have a non-circular cross section. The light source assembly may be configured such that the first light beam and the second light beam comprise different wavelengths.

In another aspect, an additive manufacturing method includes directing a first light beam and a second light beam into a beam combiner to form a common light beam, directing the common light beam towards a mirror scanner, and scanning the common light beam along a scan path across a top layer of a feed material on a platform with the mirror scanner.

Implementations may include one or more of the following features.

The first light beam may be produced with a first light source, and the second light beam may be produced with a second light source. A third light beam may be produced with a light source, the third light beam may be split into the first light beam and the second light beam, and the first light beam may be modified prior to combining the first light beam and the second light beam into the common light beam.

The feed material may be fused with the second light beam, and the feed material may be pre-heated and/or heat-treated with the first light beam. A relative position of a first center of the first light beam and a second center of the second light beam may be adjusted.

In another aspect, an additive manufacturing apparatus includes a platform, a dispenser configured to deliver a plurality of successive layers of material onto the platform, a light source assembly configured to generate a first light beam and a second light beam, a first mirror scanner configured to direct the first light beam to impinge an outermost layer of feed material on the platform, a second mirror scanner configured to direct the second light beam to impinge the outermost layer of feed material, and a controller configured to cause the first mirror scanner to direct the first light beam along a scan path on the outermost layer of feed material and cause the second mirror scanner to simultaneously direct the second light beam along the scan path such that beam spots of the first light beam and the second light beam on the outermost layer of feed material overlap as the first light beam and the second light beam traverse the scan path.

Implementations may include one or more of the following features.

The first light beam and the second light beam may have a first wavelength and a different second wavelength respectively. The first light beam and the second light beam may have a first power density and a different second power density respectively. The first power density may be lower than the second power density. The beam spot of the first light beam may completely surround the beam spot of the second light beam. The first light beam may have a first impingement spot size and the second light beam may have a second impingement spot size that is different from the first impingement spot size.

Particular embodiments of the subject matter described in this specification can be implemented so as to realize one or more of the following advantages. Material properties of resulting 3D printed parts can be improved by reducing stress and distortions during manufacturing. Microstructures of materials can be modified for advantageous properties. By adjusting the process parameters for pre- or post-heating and for powder melting, laser power utilization efficiency can be improved. By adjusting the operating parameters of the two laser beams, the width and depth of melt pool can be changed to address either part building efficiency or resolution (minimum feature size) of the part. Material waste can be reduced because a bulk of the material does not experience caking.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1B are schematic diagrams including side and top views of an example additive manufacturing apparatus.

FIG. 2 is a schematic diagram of an example laser combination set-up.

FIG. 3 is a schematic diagram of an example laser combination set-up.

FIG. 4 is a schematic diagram of an example laser combination set-up.

FIGS. 5A-5D are schematic diagrams of example spatial layouts of combined laser spots.

FIG. 6 is a flowchart of an example method that can be utilized with aspects of this disclosure.

Like reference numbers and designations in the various drawings indicate like elements.

### DETAILED DESCRIPTION

In many additive manufacturing processes, energy is selectively delivered to a layer of feed material dispensed by an additive manufacturing apparatus to fuse the feed material in a pattern, thereby forming a portion of an object. For example, a light beam, e.g., a laser beam, can be reflected off a rotating polygon scanner or galvo mirror scanner whose position is controlled to drive the laser beam in a raster or vector-scan manner across the layer of feed material.

Preheating and heat-treating the feed material can aid in creating higher quality parts. In particular, preheating and heat-treatment may be needed to reduce thermal stress and to reduce the powder needed by the light beam to fuse the feed material. Unfortunately preheating and heat-treating can cause “caking” in the feed material when applied to a bulk of the material. In “caking,” the powder undergoes sintering at points of contact but remains substantially porous and does not experience significant densification, e.g., it achieves a cake-like consistency. In contrast, the body of the part should be “fused,” i.e., subjected to a temperature that melts or sinters the material in a manner that generates a substantially solid body. The caked material is typically not part of the part, but is more difficult to recycle than feed material that remains in a powder form.

This disclosure describes combining two light beams, such as laser beams, into a single light beam. A first light beam can be lower powered and have a lower power density than a second light beam. The first light beam and the second light beam are both directed towards a same point on the feed material, the first and second laser spot overlapping one another. The first light beam can be used for preheating and/or heat treating the feed material, whereas the second light beam fuses the material. The first and second light beam can have different power densities, wavelengths, and/or spot sizes. By applying the pre-heating and heat treating in an area that is limited but aligned with the light beam that causes fusing, caking can be reduced, and more of the feed material can be recycled (or can be recycled at lower cost).

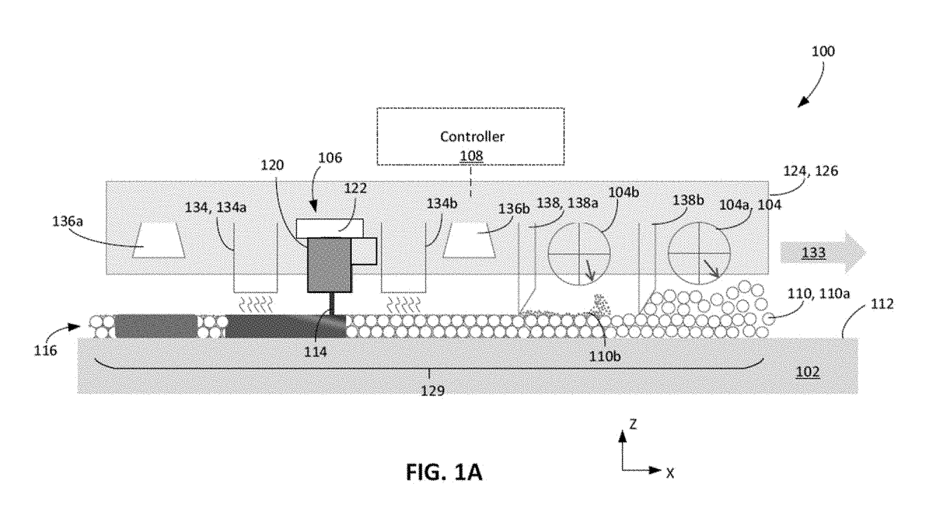

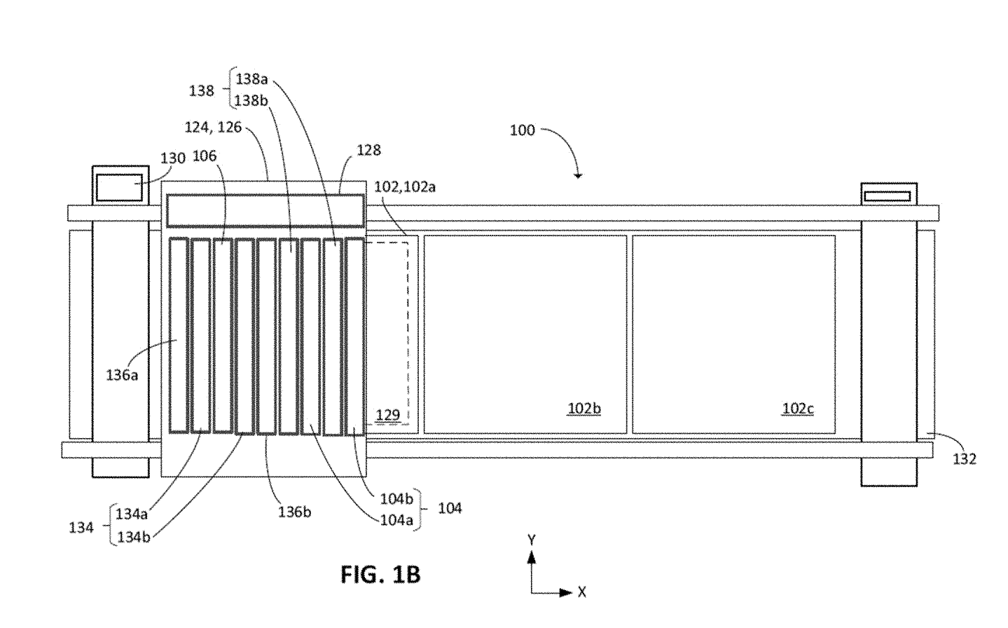

Referring to FIGS. 1A and 1B, an example of an additive manufacturing apparatus 100 includes a platform 102, a dispenser 104, an energy delivery system 106, and a controller 108. During an operation to form an object, the dispenser 104 dispenses successive layers of feed material 110 on a top surface 112 of the platform 102. The energy delivery system 106 emits a light beam 114 to deliver energy to an uppermost layer 116 of the layers of feed material 110, thereby causing the feed material 110 to be fused, for example, in a desired pattern to form the object. The controller 108 operates the dispenser 104 and the energy delivery system 106 to control dispensing of the feed material 110 and to control delivery of the energy to the layers of feed material 110. The successive delivery of feed material and fusing of feed material in each of the successively delivered layers results in formation of the object.

The dispenser 104 can be mounted on a support 124 such that the dispenser 104 moves with the support 124 and the other components, e.g., the energy delivery system 106, that are mounted on the support 124.

The dispenser 104 can include a flat blade or paddle to push feed material from a feed material reservoir across the platform 102. In such an implementation, the feed material reservoir can also include a feed platform positioned adjacent to the platform 102. The feed platform can be elevated to raise some feed material above the level of the build platform 102, and the blade can push the feed material from the feed platform onto the build platform 102.

Alternatively, or in addition, the dispenser can be suspended above the platform 102 and have one or more apertures or nozzles through which the powder flows. For example, the powder could flow under gravity, or be ejected, e.g., by a piezoelectric actuator. Control of dispensing of individual apertures or nozzles could be provided by pneumatic valves, microelectromechanical systems (MEMS) valves, solenoid valves, and/or magnetic valves. Other systems that can be used to dispense powder include a roller having apertures, and an augur inside a tube having one or more apertures.

As shown in FIG. 1B, the dispenser 104 can extend, e.g., along the Y-axis, such that the feed material is dispensed along a line, e.g., along the Y-axis, that is perpendicular to the direction of motion of the support 124, e.g., perpendicular to the X-axis. Thus, as the support 124 advances, feed material can be delivered across the entire platform 102.

The feed material 110 can include metallic particles. Examples of metallic particles include metals, alloys and intermetallic alloys. Examples of materials for the metallic particles include aluminum, titanium, stainless steel, nickel, cobalt, chromium, vanadium, and various alloys or intermetallic alloys of these metals.

The feed material 110 can include ceramic particles. Examples of ceramic materials include metal oxide, such as ceria, alumina, silica, aluminum nitride, silicon nitride, silicon carbide, or a combination of these materials, such as an aluminum alloy powder.

The feed material can be dry powders or powders in liquid suspension, or a slurry suspension of a material. For example, for a dispenser that uses a piezoelectric printhead, the feed material would typically be particles in a liquid suspension. For example, a dispenser could deliver the powder in a carrier fluid, e.g. a high vapor pressure carrier, e.g., Isopropyl Alcohol (IPA), ethanol, or N-Methyl-2-pyrrolidone (NMP), to form the layers of powder material. The carrier fluid can evaporate prior to the sintering step for the layer. Alternatively, a dry dispensing mechanism, e.g., an array of nozzles assisted by ultrasonic agitation and pressurized inert gas, can be employed to dispense the first particles.

Returning to FIG. 1A, the energy delivery system 106 includes one or more light sources 120 to emit a light beam 114. The energy delivery system 106 can further include a reflector assembly that redirects the light beam 114 toward the uppermost layer 116. Example implementations of the energy delivery system 106 are described in greater detail later within this disclosure. The reflective member is able to sweep the light beam 114 along a path, e.g., a linear path, on the uppermost layer 116. The linear path can be parallel to the line of feed material delivered by the dispenser, e.g., along the Y-axis. In conjunction with relative motion of the energy delivery system 106 and the platform 102, or deflection of the light beam 114 by another reflector, e.g., a galvo-driven mirror, a polygon scanner mirror, or another directing mechanism, a sequence of sweeps along the path by the light beam 114 can create a raster scan of the light beam 114 across the uppermost layer 116.

As the light beam 114 sweeps along the path, the light beam 114 is modulated, e.g., by causing the light source 120 to turn the light beam 114 on and off, in order to deliver energy to selected regions of the layers of feed material 110 and fuse the material in the selected regions to form the object in accordance to a desired pattern.

In some implementations, the light source 120 includes a laser configured to emit the light beam 114 toward the reflector assembly. The reflector assembly is positioned in a path of the light beam 114 emitted by the light source 120 such that a reflective surface of the reflector assembly receives the light beam 114. The reflector assembly then redirects the light beam 114 toward the top surface of the platform 102 to deliver energy to an uppermost layer 116 of the layers of feed material 110 to fuse the feed material 110. For example, the reflective surface of the reflector assembly reflects the light beam 114 to redirect the light beam 114 toward the platform 102.

In some implementations, the energy delivery system 106 is mounted to a support 122 that supports the energy delivery system 106 above the platform 102. In some cases, the support 122 (and the energy delivery system 106 mounted on the support 122) is rotatable relative to the platform 102. In some implementations, the support 122 is mounted to another support 124 arranged above the platform 102. The support 124 can be a gantry supported on opposite ends (e.g., on both sides of the platform 102 as shown in FIG. 1B) or a cantilever assembly (e.g., supported on just one side of the platform 102). The support 124 holds the energy delivery system 106 and dispensing system 104 of the additive manufacturing apparatus 100 above the platform 102.

In some cases, the support 122 is rotatably mounted on the support 124. The reflector assembly is rotated when the support 122 is rotated, e.g., relative to the support 124, thus reorienting the path of the light beam 114 on the uppermost layer 116. For example, the energy delivery system 106 can be rotatable about an axis extending vertically away from the platform 102, e.g., an axis parallel to the Z-axis, between the Z-axis and the X-axis, and/or between the Z-axis and the Y-axis. Such rotation can change the azimuthal direction of the path of the light beam 114 along the X-Y plane, i.e., across the uppermost layer 116 of feed material.

In some implementations, the support 124 is vertically movable, e.g., along the Z-axis, in order to control the distance between the energy delivery system 106 and dispensing system 104 and the platform 102. In particular, after dispensing of each layer, the support 124 can be vertically incremented by the thickness of the layer deposited, so as to maintain a consistent height from layer-to-layer. The apparatus 100 further can include an actuator 130 (see FIG. 1B) configured to drive the support 124 along the Z-axis, e.g., by raising and lowering horizontal support rails to which the support 124 is mounted.

Various components, e.g., the dispenser 104 and energy delivery system 106, can be combined in a modular unit, a printhead 126, that can be installed or removed as a unit from the support 124. In addition, in some implementations the support 124 can hold multiple identical printheads, e.g., in order to provide modular increase of the scan area to accommodate larger parts to be fabricated.

Each printhead 126 is arranged above the platform 102 and is repositionable along one or more horizontal directions relative to the platform 102. The various systems mounted to the printhead 126 can be modular systems whose horizontal position above the platform 102 is controlled by a horizontal position of the printhead 126 relative to the platform 102. For example, the printhead 126 can be mounted to the support 124, and the support 124 can be movable to reposition the printhead 126.

In some implementations, an actuator system 128 includes one or more actuators engaged to the systems mounted to the printhead 126. For movement along the X-axis, in some cases, the actuator 128 is configured to drive the printhead 126 and the support 124 in their entireties relative to the platform 102 along the X-axis. For example, the actuator can include rotatable gear that engages a geared surface on a horizontal support rail. Alternatively, or additionally, the apparatus 100 includes a conveyor on which the platform 102 is located. The conveyor is driven to move the platform 102 along the X-axis relative to the printhead 126.

The actuator 128 and/or the conveyor causes relative motion between the platform 102 and the support 124 such that the support 124 advances in a forward direction 133 relative to the platform 102. The dispenser 104 can be positioned along the support 124 ahead of the energy delivery system 106 so that feed material 110 can be first dispensed, and the recently dispensed feed material can then be cured by energy delivered by the energy delivery system 106 as the support 124 is advanced relative to the platform 102.

In some implementations, the printhead(s) 126 and the constituent systems do not span the operating width of the platform 102. In this case, the actuator system 128 can be operable to drive the system across the support 124 such that the printhead 126 and each of the systems mounted to the printhead 126 are movable along the Y-axis. In some implementations (shown in FIG. 1B), the printhead(s) 126 and the constituent systems span the operating width of the platform 102, and motion along the Y-axis is not necessary.

In some cases, the platform 102 is one of multiple platforms 102a, 102b, and 102c. Relative motion of the support 124 and the platforms 102a-102c enables the systems of the printhead 126 to be repositioned above any of the platforms 102a-102c, thereby allowing feed material to be dispensed and fused on each of the platforms, 102a, 102b, and 102c, to form multiple objects. The platforms 102a-102c can be arranged along the direction of forward direction 133.

In some implementations, the additive manufacturing apparatus 100 includes a bulk energy delivery system 134. For example, in contrast to delivery of energy by the energy delivery system 106 along a path on the uppermost layer 116 of feed material, the bulk energy delivery system 134 delivers energy to a predefined area of the uppermost layer 116. The bulk energy delivery system 134 can include one or more heating lamps, e.g., an array of heating lamps, that when activated, deliver the energy to the predefined area within the uppermost layer 116 of feed material 110.

The bulk energy delivery system 134 is arranged ahead of or behind the energy delivery system 106, e.g., relative to the forward direction 133. The bulk energy delivery system 134 can be arranged ahead of the energy delivery system 106, for example, to deliver energy immediately after the feed material 110 is dispensed by the dispenser 104. This initial delivery of energy by the bulk energy delivery system 134 can stabilize the feed material 110 prior to delivery of energy by the energy delivery system 106 to fuse the feed material 110 to form the object. The energy delivered by the bulk energy delivery system can be sufficient to raise the temperature of the feed material above an initial temperature when dispensed, to an elevated temperature that is still lower than the temperature at which the feed material melts or fuses. The elevated temperature can be below a temperature at which the powder becomes tacky, above a temperature at which the powder becomes tacky, but below a temperature at which the powder becomes caked, or above a temperature at which the powder becomes caked.

Alternatively, the bulk energy delivery system 134 can be arranged behind the energy delivery system 106, for example, to deliver energy immediately after the energy delivery system 106 delivers energy to the feed material 110. This subsequent delivery of energy by the bulk energy delivery system 134 can control the cool-down temperature profile of the feed material, thus providing improved uniformity of curing. In some cases, the bulk energy delivery system 134 is a first of multiple bulk energy delivery systems 134a, 134b, with the bulk energy delivery system 134a being arranged behind the energy delivery system 106 and the bulk energy delivery system 134b being arranged ahead of the energy delivery system 106.

Optionally, the apparatus 100 includes a first sensing system 136a and/or a second sensing system 136b to detect properties, e.g., temperature, density, and material, of the layer 116, as well as powder dispensed by the dispenser 104. The controller 108 can coordinate the operations of the energy delivery system 106, the dispenser 104, and, if present, any other systems of the apparatus 100. In some cases, the controller 108 can receive user input signal on a user interface of the apparatus or sensing signals from the sensing systems 136a, 136b of the apparatus 100, and control the energy delivery system 106 and the dispenser 104 based on these signals.

Optionally, the apparatus 100 can also include a spreader 138, e.g., a roller or blade, that cooperates with first the dispenser 104 to compact and/or spread feed material 110 dispensed by the dispenser 104. The spreader 138 can provide the layer with a substantially uniform thickness. In some cases, the spreader 138 can press on the layer of feed material 110 to compact the feed material 110. The spreader 138 can be supported by the support 124, e.g., on the printhead 126, or can be supported separately from the printhead 126.

In some implementations, the dispenser 104 includes multiple dispensers 104a, 104b, and the feed material 110 includes multiple types of feed material 110a, 110b. A first dispenser 104a dispenses the first feed material 110a, while a second dispenser 104b dispenses the second feed material 110b. If present, the second dispenser 104b enables delivery of a second feed material 110b having properties that differ from those of the first feed material 110a. For example, the first feed material 110a and the second feed material 110b can differ in material composition or average particle size.

In some implementations, the particles of the first feed material 110a can have a larger mean diameter than the particles of the second feed material 110b, e.g., by a factor of two or more. When the second feed material 110b is dispensed on a layer of the first feed material 110a, the second feed material 110b infiltrates the layer of first feed material 110a to fill voids between particles of the first feed material 110a. The second feed material 110b, having a smaller particle size than the first feed material 110a, can achieve a higher resolution.

In some cases, the spreader 138 includes multiple spreaders 138a, 138b, with the first spreader 138a being operable with the first dispenser 104a to spread and compact the first feed material 110a, and the second spreader 138b being operable with the second dispenser 104b to spread and compact the second feed material 110b.

The energy delivery system 106 combines two light beams, such as laser beams, so that the beams overlap. The first light beam can be used for fusing the feed material, and can be considered to be a “melting beam” or “fusing beam.” The second light beam can be used for pre-heating or heat-treating the feed material, and can be considered to be an “assist beam.”

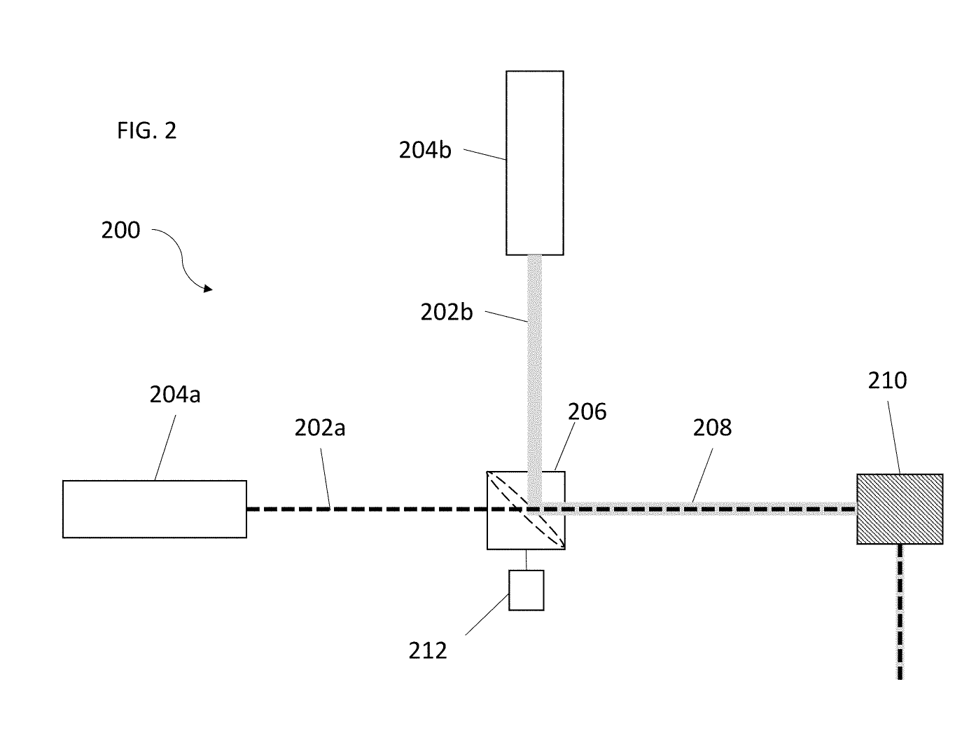

FIG. 2 is an example light source assembly 200 that can be used for the light source 120 and reflector assembly. The light source assembly 200 is configured to generate a first light beam 202a with a first light sub-source 204a and a second light beam 202b with a second light sub-source 204b. A beam combiner 206 is configured to combine the first light beam 202a and the second light beam 202b into a common light beam 208. The first light sub-source 204a is configured to generate the first light beam 202a directed towards the beam combiner 206. The second light sub-source 204b is configured to generate the second light beam 202b directed towards the beam combiner 206 as well. The individual light beams 202a, 202b in the combined light beam 208 propagate in parallel. In some implementations, the light beams 202a, 202b are coaxial.

A mirror scanner 210 is configured to direct the common light beam 208 from the beam combiner 206 towards the platform 102 to deliver energy along a scan path on an outermost layer of feed material 110. The mirror scanner 210 can include a galvo mirror scanner, a polygon mirror scanner, and/or another beam directing mechanism. In some implementations, one or more focusing lenses can be included with the mirror scanner 210. The one or more focusing lenses are configured to adjust a spot size of the common light beam 208.

In the illustrated implementation, the light source assembly 200 is configured such that the second light beam 202b has a larger beam size than the first light beam 202a. That is, the light source assembly 200 is configured such that the second light beam 202b has a second beam radius that is greater than a first radius of the first light beam 202a. The first light beam 202a and the second light beam 202b at least partially overlap to provide the common light beam. In particular, the light source assembly 200 and beam combiner 206 can be configured such that the second light beam 202b completely surrounds the first light beam 202a.

The first light beam 202a has a first power density and the second light beam 202b has a second power density that is different from the first power density. In some implementations, the second power density is less than the first power density. In some implementations, the first power density is less than the second power density. In some implementations, the light source assembly 200 is configured such that the first light beam 202a and the second light beam 202b include different wavelengths from one another. However, in any of these cases, the region where the first light beam 202a and the second light beam 202b overlap will have a combined intensity that is greater than either of the individual light beams.

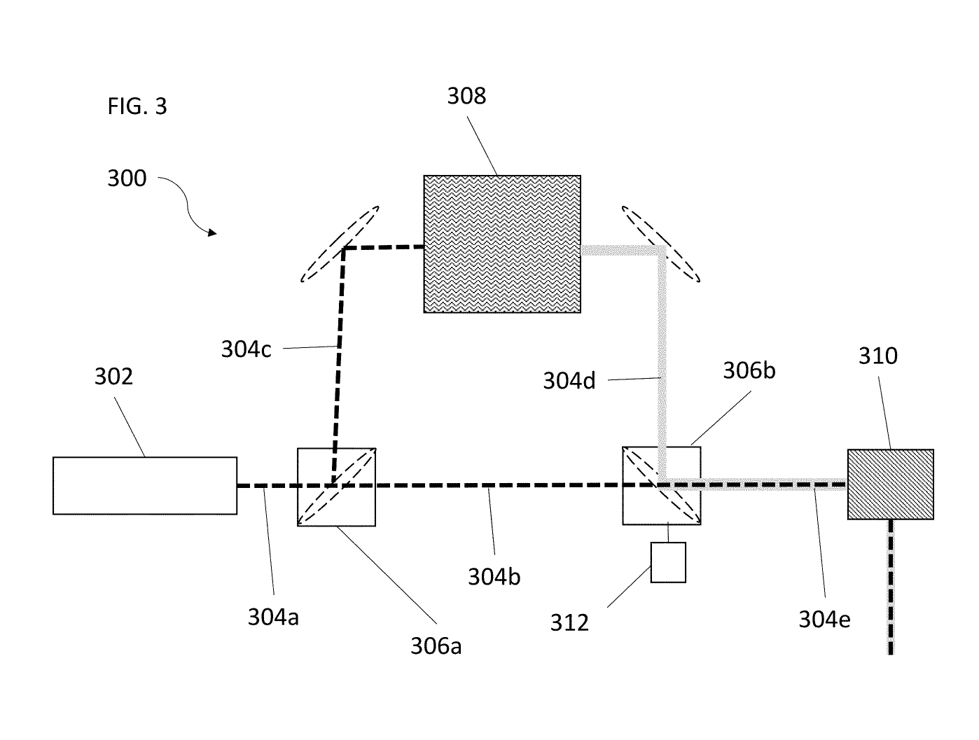

FIG. 3 is another example light source assembly 300 that can be used for the light source 120 and reflector assembly. A light source 302 is configured to generate an initial “third” light beam 304a. A beam splitter 306a is configured to split the initial light beam 304a into the “first” light beam 304b and a fourth light beam 304c. The fourth light beam 304c is directed to an optical conditioner 308. The optical conditioner 308 includes one or more optical components configured to modify a property of the fourth light beam 304c relative to the second light beam 304b to generate a modified beam 304d, which can provide the “second” light beam. For example, the optical conditioner 308 can expand the beam size of the fourth light beam. The modified “second” light beam 304d is combined with the “first” light beam 304b, e.g., by a beam combiner 306b.

The optical conditioner can include a set of lenses, filters, beam shapers, or other optical components. The optical conditioner 308 can be configured to modify a wavelength, power density, spatial beam profile or beam shape, polarization, or size or diameter of a light beam.

The beam combiner 306b is configured to direct the common light beam 304e towards a mirror scanner 310. The mirror scanner 310 is configured to direct the common light beam 304e from the beam combiner 306b towards the platform 102 to deliver energy along a scan path on an outermost layer of feed material 110. The mirror scanner 310 can include a galvo mirror scanner, a polygon mirror scanner, and/or another beam directing mechanism. In some implementations, one or more focusing lenses can be included with the mirror scanner 310. The one or more focusing lenses can be configured to adjust a spot size of the common light beam 304e. The individual light beams 304b, 304d in the combined light beam 304e propagate in parallel. In some implementations, the light beams 304b, 304d are coaxial.

Although FIG. 3 illustrates the modified beam 304d as providing the second, wider beam, the opposite configuration can be implemented. In this case, the beam splitter 306a is configured to split the initial light beam 304a into the “second” light beam 304b and a fourth light beam 304c, and the optical conditioner 308 modifies the fourth light beam, e.g., by focusing and reducing the beam diameter, to provide the “first” light beam.

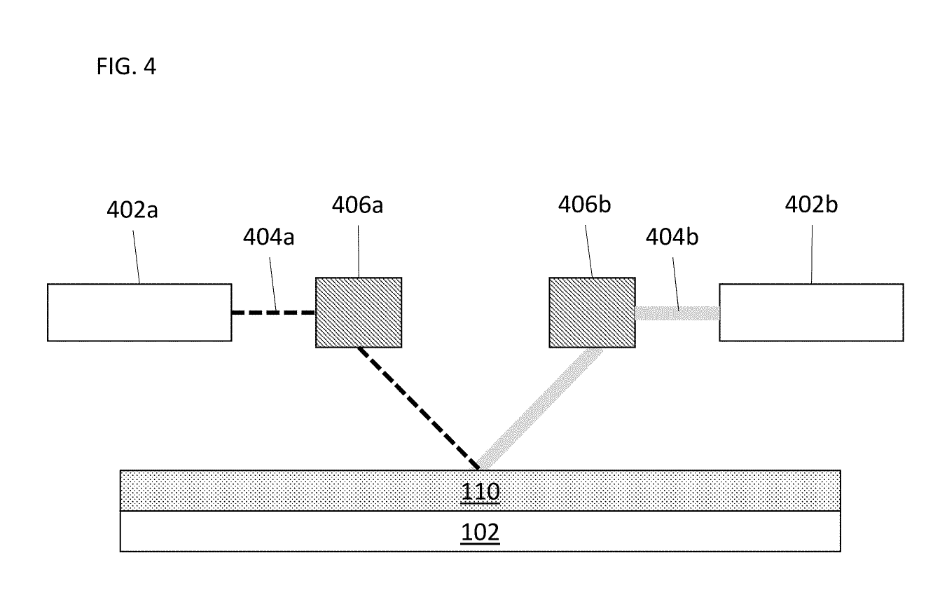

FIG. 4 is another example light source assembly 400 that can be used for the light source 120 and reflector assembly. In the illustrated implementation, a first light source 402a is configured to generate a first light beam 404a. A first mirror scanner 406a is configured to direct the first light beam 404a to impinge an outermost layer of feed material 110 on the platform 102. A second light source 402b is configured to generate a second light beam 404b. A second mirror scanner 406b is configured to direct the second light beam 404b to impinge the outermost layer of feed material 110 as well. The first mirror scanner 406a and the second mirror scanner 406b can include a galvo mirror scanner, a polygon mirror scanner, and/or another beam directing mechanism. In some implementations, one or more focusing lenses can be included with the first mirror scanner 406a and/or the second mirror scanner 406b. The one or more focusing lenses can be configured to adjust a spot size of the first light beam 404a, the second light beam 404b, or both.

In this implementation, the controller 108 is configured to cause the first mirror scanner 406a to direct the first light beam 404a along a scan path on the outermost layer of feed material 110 and cause the second mirror scanner 406b to simultaneously direct the second light beam 404b along the scan path such that beam spots of the first light beam 404a and the second light beam 404b overlap on the outermost layer of feed material 110 as the first light beam 404a and the second light beam 404b traverse the scan path.

In some implementations, the first light beam 404a and the second light beam 404b have a first wavelength and a different second wavelength, respectively. In some implementations, the first light beam 404a and the second light beam 404b have a first power density and a different second power density, respectively. In some instances, the first power density is higher than the second power density. In some implementations, the beam spot of the second light beam 404b completely surrounds the beam spot of the first light beam 404a. In some implementations, the first light beam has a first impingement spot size and the second light beam has a second impingement spot size that is different from the first impingement spot size.

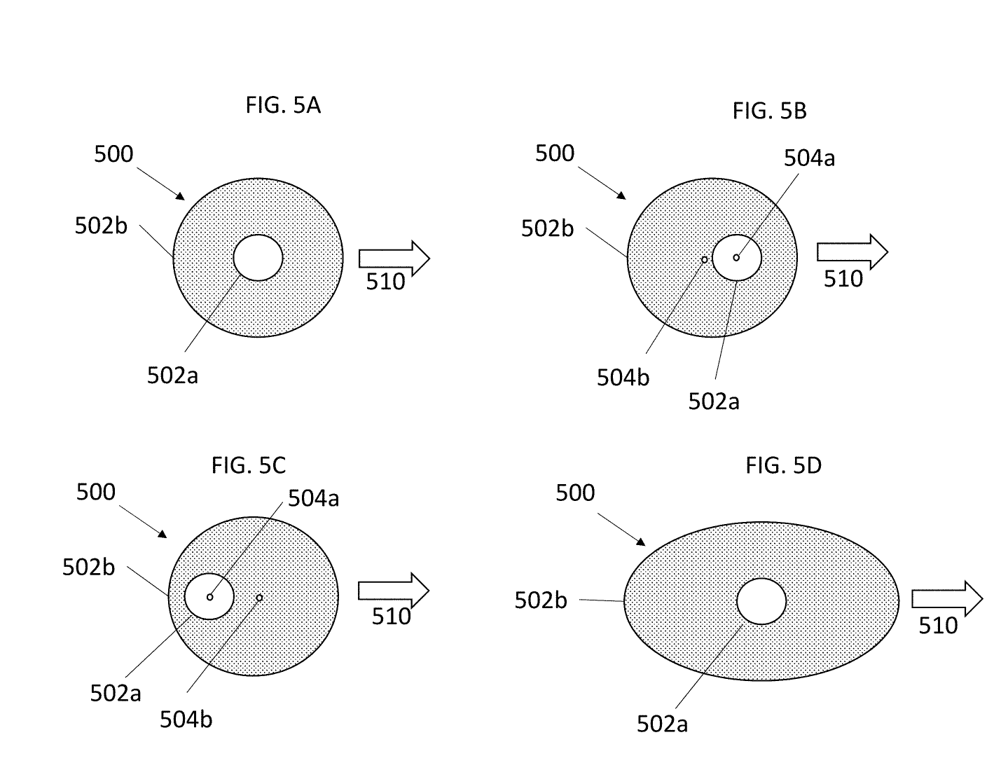

FIGS. 5A-5D are example spatial layouts of combined light spots 500 at an impingement surface. That is, they are example diagrams of a first light spot 502a and a second light spot 502b that overlap at the surface of the feed material to provide a combined spot 500. The first light spot 502a can be generated by the first light beam, and the second light spot 502b can be generated by the second light beam.

The spots can overlap because the light beams have been combined to form a common beam, e.g., as described with reference to FIGS. 2-3, or because the light beams are directed to impinge overlapping areas on the feed material, e.g., as described with reference to FIG. 4. In particular, in some implementations, the second light spot 502b completely overlaps and surrounds the first light spot 502a. Alternatively, in some implementations, an edge of the first light spot 502a can abut or very slightly extend past the edge of the second light spot 502b. The second light spot 502b can be about 2-50 times larger in diameter (or along the short axis if one beam is elongated) than the first light spot 502a. Typically, the second light spot 502b, e.g., from the assist beam, will have a beam diameter at least twice that of the first light spot 502a, e.g., from the melting beam. In the case that the two beams have different wavelengths, the assisting beam may have a beam size equal to or larger than the melting beam.

As illustrated in FIG. 5A, a beam combiner is configured such that the first light beam and the second light beam are coaxial. As such, the first light beam spot 502a and the second light beam spot 502b are concentric. In some instances, the relative orientation of the first light beam spot 502a and the second light beam spot 502b remains substantially the same as the combined spot 500 moves along a direction of motion 510.

In another example, illustrated in FIGS. 5B and 5C, the light source assembly and beam combiner are configured such that a first center 504a of the first light beam spot 502a is offset from a second center 504b of the second light beam spot 502b. In particular, the center 504a of the smaller light spot 502a can be offset from the center 504b of the larger light spot 502b in a direction parallel to the direction of motion 510 of the combined spot 500. In some implementations, as shown in FIG. 5B, the smaller light spot 502a is offset in the same the direction as the direction of motion 510 of the combined spot 500. This can be useful when the assist beam is to be used for heat treatment. In some implementations, as shown in FIG. 5C, the smaller light spot 502a is offset in the same the direction as the direction of motion 510 of the combined spot 500. This can be useful when the assist beam is to be used for pre-heating.

In some implementations, such as that shown in FIG. 5D, the second light beam spot 502b can include a non-circular cross section, e.g., an elliptical cross-section. The long axis of the elliptical cross-section can extend along the direction of motion 510 of the combined spot 500. In addition, the non-circular cross-section shown in FIG. 5D can be combined with the offset smaller spot 502a shown in FIG. 5B or 5C. In addition, the first light beam spot 502a can have non-circular, e.g., elliptical, cross-section, and this can be coaxial as shown in FIG. 5A or offset as shown in FIG. 5B or 5C.

As a result of the combined beams, there is an increase in energy density within the smaller spot 502a in relation to larger spot 502b. While the illustrated implementation shows circles with sharp edges, each spot can have a non-uniform power distribution, such as a Gaussian distribution. In some implementations, the larger spot 502b can be used for pre-heating and/or heat treating the feed powder 110, whereas the smaller spot 502a can be used for fusing the feed powder 110.

Because the larger spot 502a is smaller than the full area of the platform, e.g., smaller than the area that would be typically heated by a separate lamp, pre-heating and/or heat treating can be conducted in an area that is aligned with the light beam that causes fusing, but still limited. Consequently, caking can be reduced, and more of the feed material can be recycled (or can be recycled at lower cost).

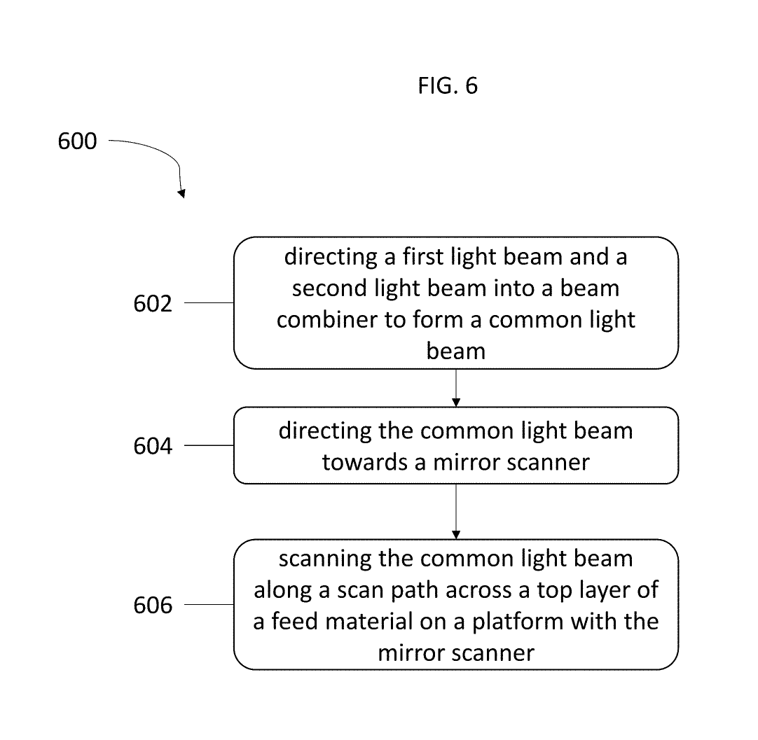

FIG. 6 is a flowchart of an example method 600 that can be used with aspects of this disclosure. A first light beam and a second light beam are directed into a beam combiner to form a common light beam (602). In some implementations, the first light beam is produced with a first light source, and the second light beam is produced with a second light source. In some implementations, a single light beam is produced with a single light source. In such an instance, the single light beam is split into the first light beam and the second light beam. The first light beam can be conditioned prior to combining the first light beam and the second light beam into the common light beam. The common light beam is directed towards a mirror scanner (604). The common light beam is scanned along a scan path across a top layer of a feed material on a platform with the mirror scanner (606). The mirror scanner can include a galvo mirror scanner, a polygon mirror scanner, or another combination of light beam directing mechanisms. The feed material is pre-heated with the second light beam, fused with the first light beam, and heat-treated with the second light beam. Alternatively, the feed material can be just pre-heated with the second light beam, and fused with the first light beam. Alternatively, the feed material can be just fused with the first light beam, and heat-treated with the second light beam.

In some implementations, a relative position of a first center of the first light beam and a second center of the second light beam is adjustable. For example, returning to FIG. 2, an actuator 212, e.g., a stepper motor, can be connected to the beam combiner 206. The actuator 212 can be configured to move the beam splitter parallel to one of the beams, e.g., the first beam 202a or the second beam 202b, and thus adjust the relative position of impingement of the beams 202a, 202b on the beam combiner 206. This adjusts a first center of the first light beam relative to a second center of the second light beam in the combined beam 208. A similar configuration is possible for the implementation shown in FIG. 3, with an actuator 312, e.g., a stepper motor, connected to the beam combiner 306b and configured to move the beam splitter parallel to the second beam 302b or the fourth beam 302d.

Controllers and computing devices can implement these operations and other processes and operations described herein. As described above, the controller 108 can include one or more processing devices connected to the various components of the apparatus 100. The controller 108 can coordinate the operation and cause the apparatus 100 to carry out the various functional operations or sequence of steps described above.

The controller 108 and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

The controller 108 and other computing devices part of systems described herein can include non-transitory computer readable medium to store a data object, e.g., a computer aided design (CAD)-compatible file that identifies the pattern in which the feed material should be deposited for each layer. For example, the data object could be a STL-formatted file, a 3D Manufacturing Format (3MF) file, or an Additive Manufacturing File Format (AMF) file. In addition, the data object could be other formats such as multiple files or a file with multiple layer in tiff, jpeg, or bitmap format. For example, the controller could receive the data object from a remote computer. A processor in the controller 108, e.g., as controlled by firmware or software, can interpret the data object received from the computer to generate the set of signals necessary to control the components of the additive manufacturing apparatus 100 to fuse the specified pattern for each layer.

The processing conditions for additive manufacturing of metals and ceramics are significantly different than those for plastics. For example, in general, metals and ceramics require significantly higher processing temperatures. Thus, 3D printing techniques for plastic may not be applicable to metal or ceramic processing and equipment may not be equivalent. However, some techniques described here could be applicable to polymer powders, e.g. nylon, ABS, polyetheretherketone (PEEK), polyetherketoneketone (PEKK) and polystyrene.

While this disclosure contains many specific implementation details, these should not be construed as limitations on the scope of what may be claimed, but rather as descriptions of features specific to particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described program components and systems can generally be integrated together in a single product or packaged into multiple products.

Thus, particular implementations of the subject matter have been described. Other implementations are within the scope of the following claims.
Optionally, some parts of the additive manufacturing system 100, e.g., the build platform 102 and feed material delivery system, can be enclosed by a housing. The housing can, for example, allow a vacuum environment to be maintained in a chamber inside the housing, e.g., pressures at about 1 Torr or below. Alternatively, the interior of the chamber can be a substantially pure gas, e.g., a gas that has been filtered to remove particulates, or the chamber can be vented to atmosphere. Pure gas can constitute inert gases such as argon, nitrogen, xenon, and mixed inert gases.
The beam combiners and beam splitters can be implemented, for example, with partially reflective mirrors, dichroic mirrors, optical wedges, or fiber optic splitters and combiners.
The diode lasers with 400-500 nm may be used for the light source, e.g., for the second light source 204b. An advantage is that this wavelength has better absorption in metals than the IR fiber lasers, and diode lasers are reaching higher power.

In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. An additive manufacturing apparatus comprising:
a platform;
a dispenser configured to deliver a plurality of successive layers of feed material onto the platform;
a light source assembly to generate a first light beam and a second light beam;
a beam combiner configured to combine the first light beam and the second light beam into a common light beam; and
a mirror scanner configured to direct the common light beam towards the platform to deliver energy along a scan path on an outermost layer of feed material.

2. The additive manufacturing apparatus of claim 1, wherein the light source assembly includes:
a first light source configured to generate the first light beam directed towards the beam combiner; and
a second light source configured to generate the second light beam directed towards the beam combiner.

3. The additive manufacturing apparatus of claim 1, wherein the light source assembly includes:
a light source configured to generate a third light beam;
a beam splitter configured to split the third light beam into the first light beam and the second light beam; and
a one or more optical components configured to modify a property of the first light beam relative to the second light beam before the first light beam is combined with the second light beam by the beam combiner.

4. The additive manufacturing apparatus of claim 1, wherein the light source assembly is configured such that the second light beam has a larger beam size than the first light beam.

5. The additive manufacturing apparatus of claim 4, wherein the light source assembly and beam combiner are configured such that the second light beam completely surrounds the first light beam.

6. The additive manufacturing apparatus of claim 5, wherein the first light beam comprises a first power density and the second light beam comprises a second power density that is different from the first power density.

7. The additive manufacturing apparatus of claim 6, wherein the second power density is less than the first power density.

8. The additive manufacturing apparatus of claim 4, wherein the light source assembly is configured such that the second light beam has a first beam radius that is greater than a second radius of the first light beam.

9. The additive manufacturing apparatus of claim 4, wherein the light source assembly and beam combiner are configured such that a center of the first light beam is offset from a center of the second light beam.

10. The additive manufacturing apparatus of claim 1, wherein the beam combiner is configured such that the first light beam and the second light beam are coaxial in the common light beam.

11. The additive manufacturing apparatus of claim 1, wherein the first light beam comprises a non-circular cross section.

12. The additive manufacturing apparatus of claim 1, wherein the light source assembly is configured such that the first light beam and the second light beam comprise different wavelengths.

13. An additive manufacturing method comprising:
directing a first light beam and a second light beam into a beam combiner to form a common light beam;
directing the common light beam towards a mirror scanner; and
scanning the common light beam along a scan path across a top layer of a feed material on a platform with the mirror scanner.

14. The additive manufacturing method of claim 13, further comprising:
producing the first light beam with a first light source; and
producing the second light beam with a second light source.

15. The additive manufacturing process of claim 13, further comprising:
producing a third light beam with a light source;
splitting the third light beam into the first light beam and the second light beam; and
conditioning the first light beam prior to combining the first light beam and the second light beam into the common light beam.

16. The additive manufacturing method of claim 13, further comprising:
pre-heating and/or heat-treating the feed material with the second light beam; and
fusing the feed material with the first light beam.

17. The additive manufacturing method of claim 13, further comprising:
adjusting a relative position of a first center of the first light beam and a second center of the second light beam.

18. An additive manufacturing apparatus comprising:
a platform;
a dispenser configured to deliver a plurality of successive layers of material onto the platform;
a light source assembly configured to generate a first light beam and a second light beam;
a first mirror scanner configured to direct the first light beam to impinge an outermost layer of feed material on the platform;
a second mirror scanner configured to direct the second light beam to impinge the outermost layer of feed material; and
a controller configured to cause the first mirror scanner to direct the first light beam along a scan path on the outermost layer of feed material and cause the second mirror scanner to simultaneously direct the second light beam along the scan path such that beam spots of the first light beam and the second light beam on the outermost layer of feed material overlap as the first light beam and the second light beam traverse the scan path.

19. The additive manufacturing apparatus of claim 18, wherein a first power density of the first light beam is greater than a second power density of the second light beam.

20. The additive manufacturing apparatus of claim 19, wherein the beam spot of the second light beam is larger than the beam spot of the first light beam.
